(19) United States
(12) Patent Application Publication
(10) Pub. No.: US 2013/0008426 A1
(43) Pub. Date: Jan. 10, 2013

(54) CONVECTION COOKING USING BAKE ELEMENT HEATER

(75) Inventors: Paul E. Newsom, Louisville, KY (US); Gregory Owen Miller, Louisville, KY (US); Paul Bryan Cadima, Louisville, KY (US)

(73) Assignee: General Electric Company

(21) Appl. No.: 13/177,758

(22) Filed: Jul. 7, 2011

(51) Int. Cl. A21B 1/00

(52) U.S. Cl. 126/21 A

(57) ABSTRACT

A bake element is used in conjunction with a remotely mounted convection fan assembly to provide a new convection cooking system. The convection fan preferably extends along a base portion of the rear wall to direct heated air flow through openings in an upper portion of the rear wall, circulate through the oven cavity, and exit through openings preferably in base portions of the side walls where the air is drawn into a bake element cavity and warmed or heated by the bake element before being recirculated.

### BACKGROUND OF THE DISCLOSURE

This disclosure relates to a cooking appliance, and more particularly, an oven that provides for circulated air that distributes hot air through an oven cavity to evenly cook and brown food products in less time with convection heat.

In a conventional oven that uses a bake element to heat an oven cavity, certain foods are prepared best. For example, less tender cuts of meat use regular cooking because the meat can reside in a liquid and thereby allow the meat to become more tender. Use of a cooking bag and foil tent, as well as covered dishes, may also be desirably cooked with just the bake element and no circulating air.

A convection oven is generally known in the art and is desirable because food is heated faster when using a convection mode. Certain types of food can be cooked at lower temperatures than the temperatures suggested for a regular oven. Convection baking or roasting employs an additional heating element typically disposed along a rear wall of the oven cavity, and a convection fan that is located adjacent the auxiliary heating element to circulate heated air evenly, over, and around the food product. As a result of the fan circulating the heated air throughout the oven cavity, evenly browned, baked food products can be prepared on shelves disposed at different locations in the oven cavity. Further, large quantities of baked foods can be cooked as a result of the circulating heated air. Preheating may be unnecessary in some instances, cooking times may be potentially reduced, and cooking temperatures may be advantageously reduced with convection baking when compared to conventional baking.

In convection ovens, the main bake element is typically not employed during convection baking and only the additional heating element surrounds the fan blade to heat the air. Further, the additional convection heating element and fan extend into the cooking cavity approximately 1″ to 1½″ and thus space is potentially wasted within the oven cavity with the convection heating element and associated fan. In addition, there is a redundancy in components, i.e., there is provided a main bake element that is either exposed or hidden beneath a pan in the lower portion of the oven cavity, but the main bake element is not used in favor of an additional convection heater during convection baking.

The motor employed to operate the fan in present convection ovens is exposed to the high, self-cleaning temperatures. Therefore, the motor and bearing components are subject to premature failure in an extreme, high-temperature environment associated with self-cleaning.

Accordingly, a need exists for an improved cooking apparatus or oven that has convection capabilities with increased volume in the oven cavity, eliminates redundancy of components, and allows use of the main bake element of the heater for convection airflow.

### SUMMARY OF THE DISCLOSURE

A cooking apparatus includes a housing having walls that form an oven cavity and receive a bake element therein. A first opening in a first wall of the housing is located adjacent an upper portion of the first wall. A second opening is located adjacent a lower portion of a second wall. A passage external of the housing walls is in air communication with the first opening, and a convection fan is located along the passage for urging air flow toward the first opening.

The convection fan is remotely located from the second opening and draws heated air from adjacent the bake element into the passage.

A pan at least partially covers the bake element mounted in the oven cavity adjacent a bottom wall thereof so that the convection fan draws heated air from the bake element cavity, through the passage to openings in an upper portion of a rear wall. Thereafter, air is drawn through the outlet openings in a base portion of the side wall to be heated anew in the bake element passage.

A drive motor of the convection fan is positioned outside of the cooking chamber.

Preferably, the convection fan has a tangential inlet and extends along substantially an entire width of the rear wall of the oven cavity.

A primary benefit of the disclosure is the ability to increase the volume of the oven cavity without a loss in function.

Yet another advantage of the disclosure relates to the ability to provide convection baking with a reduced number of components.

Still another benefit resides in isolating the fan from oven heat when not in use in order to improve reliability of the fan motor, and/or reduce the cost of the fan motor.

Still other features and benefits of the present disclosure will become apparent upon reading and understanding the following detailed description.

### BRIEF DESCRIPTION OF THE DRAWINGS

FIG. 1 is a prior art view of a conventional convection system incorporated into a cooking appliance such as an oven.

FIG. 2 is a perspective view of a convection cooking arrangement using a bake element.

FIG. 3 is a perspective view of a tangential fan assembly used to circulate heated air through the oven cavity.

### DETAILED DESCRIPTION OF THE PREFERRED EMBODIMENTS

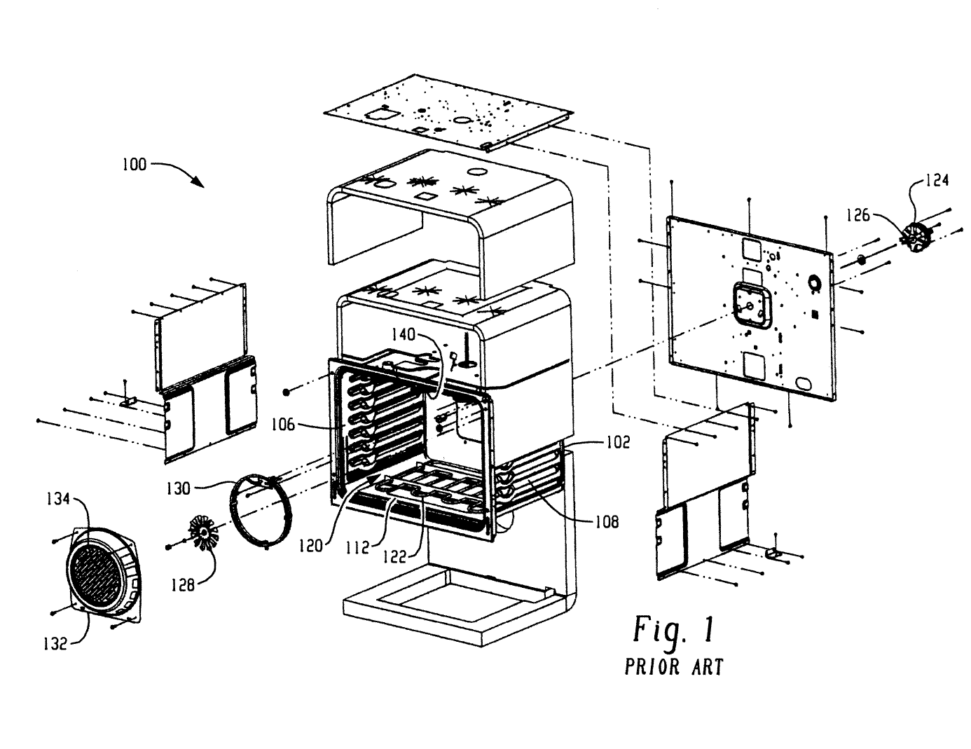

Turning first to FIG. 1, there is shown a cooking appliance or cooking apparatus usually referred to as an oven 100 that includes a housing 102 having wall portions including a first or rear wall 104, second and third or side walls 106, 108, a fourth or top wall 110, and a fifth or bottom wall 112. The walls 106, 108, 110, 112, along with the door (not shown) that may be selectively opened and closed, form an oven cavity 120. A bake element 122 is received in the oven cavity. Typically the bake element 122 is located adjacent the bottom wall of the oven cavity and may be exposed, or hidden, i.e., a pan (not shown in FIG. 1) may be disposed over the top of the bake element and at least partially cover the bake element in the oven cavity.

The oven 100 of FIG. 1 is a convection system in which motor 124 is preferably mounted along the rear wall 104 to drive shaft 126 on which is mounted fan blade 128. A convection heating element 130 is operatively mounted adjacent the fan blade 128, and the fan blade 128 and convection heating element 130 are typically enclosed within cover 132 that includes openings 134. When the convection heating element 130 and fan blade 128 are operated, air is heated by the convection heating element, and the fan blade distributes the heated air through the cover openings 134 for distribution throughout the oven cavity 120.

When the convection system is not employed, the bake element 122 is used for heating the oven cavity. Alternatively, a top or boiler element 140 shown mounted adjacent the top wall 110 is used for select cooking purposes, or top element 140 may be used in addition to the bake element 122 to heat and cook single rack food loads.

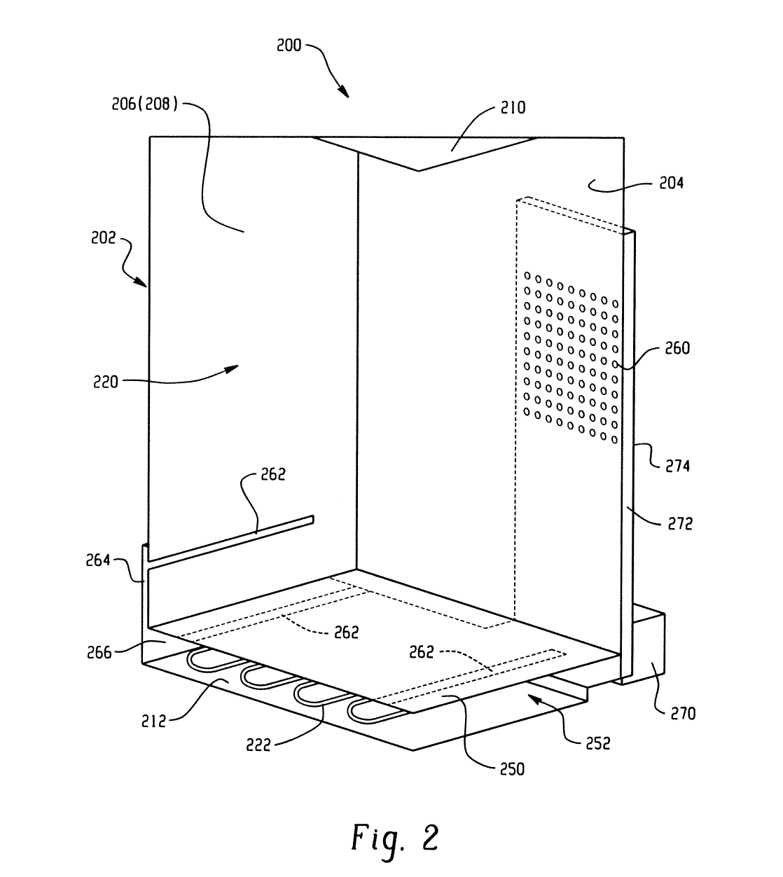

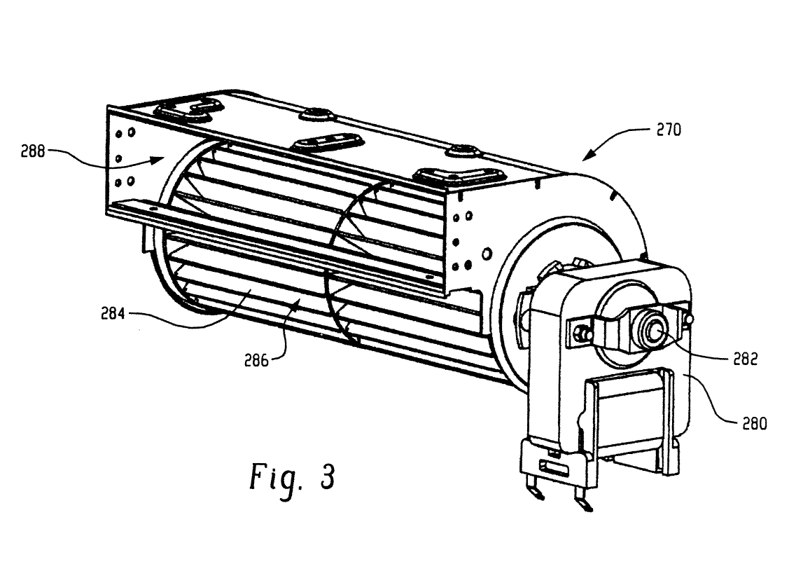

With continued reference to FIG. 1, and with additional reference to FIG. 2, modifications are provided in a new convection system 200 and more particularly illustrated in FIGS. 2 and 3. Here, like reference numerals in the 200 series are used to refer to like components. For example, housing 202 includes a rear wall 204, side walls 206, 208 (the second side wall not shown for ease of illustration), top wall 210, and bottom wall 212, and together these walls form the oven cavity 220. Like FIG. 1, the hinged door of the new convection system is not shown for ease of illustration although one skilled in the art will recognize that the door provides selective access to the oven cavity, to shelves that may be mounted at various locations in the oven cavity, and to food products that are selectively introduced and removed from the oven cavity. Bake element 222 is preferably mounted adjacent to and above the bottom wall 212 and in the preferred arrangement of the present disclosure, a pan 250 is disposed in a generally parallel arrangement to at least partially cover and form a bake element cavity 252 adjacent the bottom wall of the oven cavity. Thus, the bake element 222 is generally hidden by the pan 250, i.e., it is not exposed directly, and rather the bake element is at least partially covered by the pan.

The new convection system 200 uses the bake element 222 as the primary heat source for circulating heated air through the oven cavity. More particularly, a first opening is defined by a series of openings 260, preferably along an upper region of the first or rear wall 204. The openings 260 may adopt an orderly or random pattern in the upper portion of the rear wall and the openings are intended to generally evenly distribute air flow into the oven cavity in a manner to be described further below. It will be appreciated that various patterns for the openings may be employed and thereby contribute to the distribution pattern or airflow through the oven cavity.

A second opening 262 is preferably provided in at least one of the side walls 206, and preferably opening 262 is formed by openings provided in both of the side walls 206, 208, i.e., it will be understood that an opening 262 is provided in side wall 208 similar to the opening 262 shown in the side wall 206. The openings 262 are preferably located in a lower region of the side walls and communicate with the bake element cavity 252, along a supplemental path 264 formed by surface 266. The surface 266 preferably merges with the bottom wall 212 of the oven cavity. Alternatively, second opening(s) or slot(s) 262 can be provided in the pan 250 (shown in broken line in FIG. 2), or in both the side wall(s) 206 and/or 208, and the pan 250.

In addition, along an interconnecting region of the bottom wall 212 with the rear wall 204 of the oven cavity is provided a remotely mounted convection fan 270. The convection fan 270 withdraws air from the bake element cavity 252 into the fan and urges the heated air along passage 272 formed by passage wall 274 that preferably extends in generally parallel relation with the rear wall 204. The passage wall extends to the uppermost portion of the opening, namely to the uppermost openings 260 in the rear wall. It will also be appreciated that the passage wall 274 preferably extends over substantially the entire width of the rear wall so that the opening 260 may be provided over the entire width of the rear wall 204 if so desired and thereby contributing to the distribution of the air flow through the oven cavity 220.

With continued reference to FIG. 2, and additional reference to FIG. 3, a preferred form of a convection fan 270 is shown. Preferably, tangential fan assembly 270 includes motor 280 mounted externally of the oven walls for driving a shaft 282 that in turn drives rotor 284. The rotor 284 is preferably formed by a series of generally radially extending blades (sometimes referred to as a squirrel cage blower) so that air is drawn from the bake element cavity 252 along a tangential inlet 286 of the fan assembly and urged outwardly through outlet 288 of the fan assembly into passage 272. The tangential convection fan assembly 270 preferably extends along the entire width of the rear wall and along a lower portion of the rear wall so that the outlet 288 of the fan fits inside the ductwork or passage 272. That is, the inlet 286 of the fan assembly is preferably located along an underside of the passage 272 where the bake element 222 heats the air in bake element cavity 252. The negative pressure caused by rotation of the rotor 284 draws the heated air from the bake element cavity 252 into the convection fan 270 and urges the heated air outwardly into the passage 272 with positive pressure where the heated air is distributed through openings 260 in an upper portion of the rear wall 204. The desired amount and direction of airflow can be controlled by the size of the convection fan assembly, as well as the shape or pattern of the openings 260. Heated air is circulated throughout the oven cavity 220 and drawn by negative pressure at opening 262 where the air circulates through supplemental path 264 to enter the bake element cavity 252 for recirculation.

This new arrangement allows for the bake element 222 to be used for a convection cooking cycle and thus reduces the need for an extra element in the cavity (i.e., see FIG. 1, reference heating element 130). The convection system of FIGS. 2 and 3 also increases space in the oven cavity 220 by eliminating that using that portion of the oven cavity that was previously required to accommodate the conventional convection heating element of FIG. 1. The additional space might be used to increase the usable capacity of an oven cavity. Also, the conventional convection fan and motor is replaced by a remotely mounted fan assembly, i.e., one located outside the oven cavity. Remotely mounting the fan assembly provides for a cooler motor when not in use during the self-clean cycle, and enables less expensive bearings or lower rated components to be used since the fan assembly is not exposed to the elevated self-cleaning temperatures.

Air is pulled in through openings 262 provided near the bottom of the oven side walls, and then across the bake element 222. The air is then pulled through the convection fan 270 and urged along passage 272 to the openings 260. In addition to increasing usable volume inside the oven cavity by eliminating current convection components and a convection cover, improved convection heat transfer is achieved through more uniform impingement of heated air on food products. This system also advantageously decreases the oven bottom temperatures due to use of air flow across the underside of the oven cavity. Convection cooking allows baking foods on multiple racks stacked over each other because the air throughout the oven is used to heat the food rather than radiation from the lower or upper heaters which would impinge on only one side of one of the racks of food. For this reason, a third heater is also typically associated with the fan assembly (FIG. 1) so that the fan assembly would not radiate heat directly to one side of a rack of food. Therefore, in the present disclosure, heat from the bake element 222 (FIG. 2) is drawn into the air rather than allowing the heat to substantially elevate the temperature of the oven bottom surface (which normally turns the bottom into a direct radiating heat source), and this heat from the bake element can be advantageously redirected via convection rather than radiant or combination radiant/convection modes.

Although a squirrel cage fan blade assembly is illustrated, it is to be understood that other fan assemblies could be used. Likewise, although simple slots and openings are provided, more sophisticated patterns or combinations of holes, slots, louvers, etc. may be used to direct airflow in and out of the oven cavity as desired. Since air moves across the bake element, a preferred convection bake system arrangement uses a hidden bake element, i.e., one that uses the pan 250 to define a bake element cavity. Therefore, it is unlikely that an exposed baking element would be used, although the present disclosure should not be so limited.

The present disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. A cooking apparatus comprising:
a housing having walls that form an oven cavity;
a bake element disposed in the oven cavity;
a first opening in at least a first wall of the housing, the first opening located adjacent an upper portion of the first wall;
a second opening in at least a second wall of the housing;
a passage external of the housing walls in air communication with the first opening; and
a convection fan located along the passage for urging air flow toward the first opening.

2. The cooking apparatus of claim 1 wherein the convection fan is remotely located from the second opening for drawing heated air from adjacent the bake element into the passage.

3. The cooking apparatus of claim 1 wherein the second opening communicates with a bake element cavity that receives the bake element therein and adjacent a bottom wall that forms the oven cavity.

4. The cooking apparatus of claim 3 wherein the convection fan communicates with the bake element cavity for drawing heated air from the bake element cavity into the passage.

5. The cooking apparatus of claim 1 wherein the convection fan is located adjacent a base portion of the first wall and the first opening is provided in an upper portion of the first wall.

6. The cooking apparatus of claim 5 wherein the first opening includes a series of small, spaced openings.

7. The cooking apparatus of claim 5 wherein the second opening is located in a lower portion of the side wall.

8. The cooking apparatus of claim 7 wherein the second opening is located in a bottom wall that forms the oven cavity.

9. The cooking apparatus of claim 8 wherein the first wall is a rear wall forming the oven cavity.

10. The cooking apparatus of claim 9 wherein the convection fan extends along substantially an entire width dimension of the rear wall.

11. A cooking apparatus using a bake element as the heating element for providing convection cooking capabilities, the cooking apparatus comprising:
a housing having a cooking chamber formed therein;
a bake element for heating the cooking chamber;
a cooking chamber first opening for receiving airflow from the cooking chamber;
a cooking chamber second opening extending through a chamber wall for introducing airflow into the cooking chamber;
a passage leading to the second opening; and
a convection fan for directing the airflow toward the second opening.

12. The cooking apparatus of claim 11 wherein the convection fan includes a generally tangential inlet extending along substantially an entirety of a width of the cooking chamber wall.

13. The cooking apparatus of claim 12 wherein the bake element is mounted in a bake element cavity is at least partially covered in the oven cooking chamber by a pan disposed in generally overlying relation.

14. The cooking apparatus of claim 13 wherein the tangential inlet of the convection fan receives heated air from the bake element cavity and directs the heated air along the passage.

15. The cooking apparatus of claim 11 wherein the passage includes a passage wall spaced from a rear wall of the cooking chamber.

16. The cooking apparatus of claim 11 wherein the cooking chamber second opening includes a series of spaced openings formed in an upper portion of a rear wall of the cooking chamber.

17. The cooking apparatus of claim 11 wherein the cooking chamber first opening includes an opening in at least one of first and second side walls of the cooking chamber that directs air toward the bake element.

18. The cooking apparatus of claim 17 wherein the bake element is at least partially covered in the cooking chamber by a pan to form a bake element cavity, and the cooking chamber first opening communicates with the bake element cavity.

19. The cooking apparatus of claim 18 wherein the passage communicates with the bake element cavity so that heated air therefrom is drawn by the convection fan into the passage and directed to the cooking chamber second opening.

20. The cooking apparatus of claim 11 wherein the convection fan and a drive motor therefor are segregated from the cooking chamber.
